(19) United States
(12) Patent Application Publication
(10) Pub. No.: US 2002/0152264 A1
(43) Pub. Date: Oct. 17, 2002

(54) Personal vehicular internet appliance

(75) Inventor: Thomas M. Yamasaki, Orange, CA (US)

Correspondence Address: KIT M. STETINA, STETINA BRUNDA GARRED & BRUCKER, 75 ENTERPRISE, SUITE 250, ALISO VIEJO, CA, 92656, US

(73) Assignee: Zandiant Technologies, Inc.

(21) Appl. No.: 09/779,009

(22) Filed: Feb. 7, 2001

(51) Int. Cl. G06F 15/16

(52) U.S. Cl. 709/203; 709/207

(57) ABSTRACT

A network appliance that may be installed in a vehicle transmits and receives information relating to interactions between a user and the vehicle, vehicle mechanics, information relating to the user, information relating the vehicle's physical location, information relating to business locations, etc. Furthermore, the appliance accesses and interacts via a network such as the Internet with remote servers to obtain and transmit information relating to the user's relative surroundings, thereby providing the user specific personalized information.

### BACKGROUND OF THE INVENTION

1. Field of the Invention

The present invention relates to computer devices, and more particularly, to personal computer devices that can be used in a vehicle safely and effectively.

2. Background Art

In-vehicle computing systems have been incorporated into private and public vehicles for several years. Automobiles equipped with computer systems that monitor various mechanical aspects have been in use since the early 1980's. Only recently have these computer systems become complex enough to actually transmit information, such as the condition of the brakes or brake pads, timing belt, engine speed, intake air capacity, injection quantity and even wheel alignment, to a mechanic or a driver and/or user. Other uses for on-board computer systems allow driver and/or users to use global positioning and navigation systems to obtain directions to particular locations as well as determine the best route to a particular location. Public transportation systems, such as subways and busses have started using onboard networked computer systems to help transportation officials determine the efficiency of routes and allow public transportation managers methods to view exact locations of trains or busses as they travel along their relative commuter paths. Systems such as these are also finding uses in the shipping industry to help monitor the location of cruise ships, freight liners, and even personal pleasure boats.

Computer systems in general are known. A typical system comprises a computer, a keyboard, a mouse, and a monitor. Additionally, the computer comprises a central processing unit (“CPU”), random access memory (“RAM”), long term storage space in the form of hard disc drives or memory cards. Generally, various operating systems and software programs can be loaded and used, or the operating system is part of a static chip. Further, the computer might comprise a modem, an Ethernet card or other similar devices for connecting to a system of networked computers, such as the Internet. Smaller computer systems, such as systems used in portable personal communication devices, have similar computer system components. In-vehicle computing systems include similar components as well, for instance, an alphanumeric keypad on such a system can function in the same manner as a keyboard, and an LCD screen display serves as a monitor. A separate mouse-like device can also be a component of an in-vehicle computing system, used for controlling the in-vehicle computer by a direct wired connection or by wireless connections via radio waves or infra-red signaling.

Internet information is made available to the public through both public and private servers running on Internet hosts. The servers make documents or other files available to those accessing the host site. Such files can be stored in databases and on storage media such as optical or magnetic storage devices, preferably local to the host. Recent advances in wireless communications technology have allowed information on the Internet to be accessed via wireless communication devices. Currently, portable computer devices such as personal digital assistants (“PDA”), for example the PalmPilot™, offer users wireless interaction with the Internet allowing both the retrieval and submission of information.

Networking protocols can be used to facilitate communications between a host and a requesting client. Wireless application protocol (“WAP”) is one such networking protocol for wireless devices. Currently WAP supports most wireless networks including CDPD (Cellular Digital Packet Data), CDMA (Code-Division Multiple Access), GSM (Global System for Mobile Communications), PDC, PHS, TDMA (Time Division Multiple Access), FLEX and ReFLEX (flexible wide area paging protocol), iDEN® (Integrated Digital Enhanced Networks), TETRA (Terrestial Trunked Radio), DECT (European standard for digital, cordless information transmission), DataTAC, Bluetooth™ and Mobitex. Transmission control protocol/Internet protocol(“TCP/IP”) is traditionally a networking protocol for wired communications. Computers on a TCP/IP network utilize unique identification (“ID”) codes, allowing each computer or host on the Internet to be uniquely identified. Such codes can include an Internet protocol (“IP”) number or address, and corresponding network and computer names. Similarly, WAP protocols require ID codes and corresponding IP addresses when accessing information on the internet.

Created around 1991, the World-Wide Web (“Web” or “WWW”) provides access to information on the Internet, allowing a user to navigate Internet resources intuitively, without IP addresses or other specialized knowledge. The Web comprises hundreds of thousands of interconnected “pages”, or documents, which can be displayed on a user's computer monitor. The web pages are provided by hosts running special servers. Software that runs these web servers is relatively simple and is available on a wide range of computer platforms including PC's. Equally available is web browser software, used to display web pages as well as traditional non-web files on the user's system. Introduction of various wireless protocols and PDA operating systems and software, have helped increase access to the web via wireless communication devices.

Recent years have been marked by a societal and technological revolution driven by the convergence of the data processing and data storage industry with consumers via the Internet. One of these technologies is the Internet-related distribution of documents, media and programs. With the expansion that has occurred, businesses and consumers have direct access to a wide range of documents, media and even computer programs.

Many companies have started Internet sites in order to pursue representation on the Web. These sites contain databases and computer software protocols that allow the public access to product inventories, digitized samples of music or movies, and the ability to make purchases. Currently, internet users can submit personal information to a company through a web document and the information is collected and categorized in a database in a manner that provides the company with customers' historical buying or web-research habits. Internet merchants use database programs, which collect information submitted by clients, to offer clients more personalized experiences whenever the clients access a web page. Further, interactivity between online businesses and customers include providing a client with emailed communications offering coupons or suggestions, and even reminders of particular holidays.

Hypertext Markup Language (“HTML”), which has been a documentation language of the Internet and World Wide Web for years, offers direct links between pages and other documentation on the Internet and a variety of related data sources which were text at first, then evolved into other various media formats, and then progressed towards interactive documents for submission and retrieval of information. This even further exploded the use of the Internet and World Wide Web. It became possible for a web user to spend hours reviewing many documents and interact with online businesses and databases. This interaction has been further increased by offering advertisements in the form of images on web pages describing or illustrating a particular product. Recent developments in internet marketing techniques provide businesses various methods to target specific customers based on information either provided by the customer, or based on the number of times a customer interacts with a particular businesses web site document.

As mentioned above, in-vehicle computing that offers many services to drivers and/or users has become a reality. However, in traditional vehicular applications, Internet interaction for delivering useful information to the user is not carried out in a safe and efficient manner at all times. The typical user interface calls for interrupts to notify the user of events that may require the user's attention. This may pose a safety risk as a result of an interrupt that may be unnecessary or not very important. A typical operating system used is Windows CE™, which has primitive mechanisms to handle application priorities via forms and audio managers. Windows CE™, for example, lacks a mechanism to arbitrate whether an application can take over control of a form or audio.

FIG. 1 illustrates a typical Windows CE™ forms and audio implementation. A user talks on a telephone 11 with an onboard computer processing the audio. As shown in block 16, during the telephone call to a specific phone number, for example, 19495555555, transmitter 14 sends an RDS traffic announcement. At that point, as shown in block 18, the computer switches control of both the form and audio to the RDS application with the traffic announcement, which may not be a higher priority task than the telephone call.

Therefore, there is a need for an interface or appliance to facilitate access to a network such as the Internet, and to allow interaction between the network and an onboard computer to ensure that useful information is delivered to the user safely and effectively at all times. Furthermore, it is desirable for the appliance to distinguish whether an application has a priority level high enough to interrupt a current task.

### SUMMARY OF THE INVENTION

The present invention relates to methods and a network appliance for communicating (receiving and transmitting) information between a vehicle and a network such as the Internet. The methods roughly comprise obtaining information such as digital representations of interactions between a driver and/or user and a vehicle, and transmitting and/or receiving user specific information between the network appliance and the network.

Advantageously, the network appliance may be installed in any vehicle such as an automobile, and the user specific information may include user preferences, interactions between a user and a vehicle, interactions between a vehicle and an in-vehicle computer, physical location of a user and a vehicle, physical destination of a user and a vehicle, physical location of a business, and business to consumer messages.

### BRIEF DESCRIPTION OF THE DRAWINGS

Reference is now made to the following description and the accompanying drawings, wherein like reference numerals represent like parts, in which:

FIG. 1 illustrates a typical Windows CE™ forms and audio implementation;

FIG. 2 illustrates a typical computer system;

FIG. 3 is a table showing exemplary content areas provided by the network appliance with respect to operational conditions according to an embodiment of the present invention.

FIG. 4 illustrates an application priority manager implementation according to an embodiment of the present invention;

FIG. 5 is a table showing various priority level assignments according to an embodiment of the present invention; and

FIG. 6 shows a flow diagram of a system with a network appliance and a DAPM according to an embodiment of the present invention.

### DETAILED DESCRIPTION

The present invention provides methods and a network appliance for receiving and transmitting information between a vehicle and a network such as the Internet. The network appliance provides a user with information from the network, as well as with access and control of various vehicle-related applications. Further, the appliance and methods of the invention may receive and transmit information in response to interactions between the user and the vehicle.

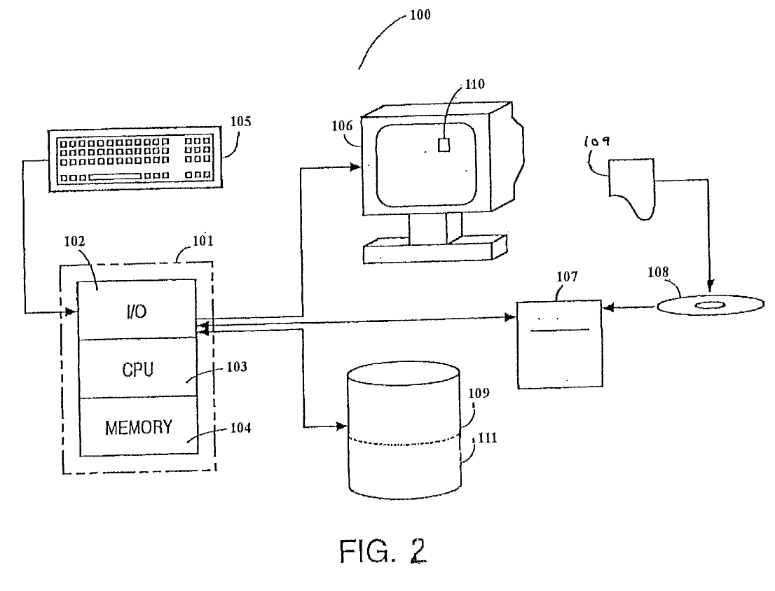

FIG. 2 illustrates a typical computer system. While the figure illustrates traditional components of a personal computer, the present invention can have components similar to those shown, and furthermore, through accessing the Internet, the appliance interacts and interfaces with components on larger computers similar to examples illustrated in the figure.

A general purpose workstation computer 100 comprises a processor 101 having an input/output (“I/O”) section 102, a central processing unit (“CPU”) 103 and a memory section 104. The I/O section 102 is connected to a keyboard 105, a display unit 106, a disk storage unit 109 and a CD-ROM drive unit 107. The CD-ROM unit 107 can read a CD-ROM medium 108 that typically contains programs and data 110. The disk storage unit can be, or is connected to, a database or network server 111. The connection can be via a modem or other digital communication devices, such as wireless receiver and transmission components as used in PDAs and wireless communication devices known to one of ordinary skill in the art. The database server and network server 111 can be the same device or two separate but coupled devices. While the scale of the components used in an internet appliance can be smaller than the components used in a larger personal computer or network server, functions of the components remain similar.

The computer 100 may be a network appliance, personal computer, desktop computer, laptop computer, set top box, web access device (such as WEBTV® (Microsoft Corporation)), or the like. Use of computers also contemplates other devices similar to or incorporating computers, such as personal computers, television interfaces, kiosks, and the like.

The computer environment in which the present invention is used comprises a system of networked computers, wherein general purpose computers, workstations, or personal computers are interconnected via communication links of various types. Thus, the user's computer and/or network appliance 100 can be connected to other computers via wireless communications protocols, over a modem, Ethernet connection, or other communications link. Electronic information transmitted from the user or other entities is sent from one such computer system 100 to other similar computer systems. The network appliance may interact, contact, connect, receive and/or transmit information to a network and/or PDA via wireless communications protocols and components.

The network appliance receives and/or transmits information and may be installed in a vehicle such as a consumer vehicle, for example a car, truck and/or a sport utility vehicle. Within aspects of the invention it is also understood that the network appliance may be installed in vehicles such as motorcycles, boats and airplanes.

It should be noted that a user includes an individual who operates a vehicle that has an appliance of the invention installed. A user may be a driver or a passenger in a vehicle that has an appliance installed, where the passenger accesses the appliance through an alphanumeric keypad or via a PDA or other wireless communication device providing the appliance with user specific information. Thus, a user can represent multiple passengers in a vehicle who transmit and/or provide information to the appliance and/or access information made available by the appliance. With regard to the present invention the number of users is not considered a limiting aspect. There can be as many users as a vehicle can safely carry as long as the users provide user specific information to the appliance. Therefore, a user can be a driver or a passenger, and a driver can be a user.

The network appliance transmits and receives digital information from a network of computers, for instance, the Internet or World Wide Web. Transmission of information may be by use of wireless communication components and wireless communication protocols. The network appliance may be connected via wireless communication protocols to the Internet or indirectly connected to a network system such as a system of networked computers through which the appliance connects to the Internet. A system of networked computers includes any system of interconnected computers such as the Internet, an intranet, a virtual private network (“VPN”), a local area network (“LAN”), a wide area network (“WAN”), and the like. The system of networked computers may be any system of multiple computers that are directly or indirectly interconnected by any type of electronic connection, including connections via hardwire, Ethernet, token ring, modem, digital subscriber line, cable modem, wireless, radio, satellite, and combinations thereof. Such connections may be implemented using copper wire, fiber optics, radio waves, coherent light, or other media.

The information transmitted may be information pertaining to user preferences, digital representations of user interactions with a vehicle and/or in-vehicle computer systems information. Other information including user and vehicle physical location, request for directions to particular locations, and information request for weather conditions, stock quotes and/or local business establishments, are also transferred by the appliance to the Internet. Information transferred to the Internet by the appliance may also be received by the appliance. Received information comprises user physical location, directions to a particular location, current weather, stock quotes and/or business establishments. Also, included in received information are digitized music and or video, and information relating to business concerns that are located near the physical location of the user and the vehicle. The business concerns may be within a local city and/or county limits, and in some instances, within a 20 mile radius, and even a 10 mile radius of the user driver and the vehicle.

Received information can be passively or actively obtained and may include digital information that is read by a computer processor, computer programs or analog information that is collected by a radio receiver. Information that is received passively is sent to the network appliance from a network of computers and/or local radio transmission stations. Passive information can also be sent via communication devices such as wireless telephones, for instance cellular phones, digital phones, PDAs, paging devices, or analog phones. The information received is provided to the user as audible information such as music and/or speech, for example, a phone conversation between a user and another, or audible directions to a requested location. The information can also be provided as digital images, as in for example, a map of directions.

Actively obtained information is provided to the user by the network appliance “scraping” of content from a network. Scraping content allows the network appliance to access a host server, web page, or network database and access user specific information. The network database, host server or web page generally has an application and/or program that accepts the network appliance request. The request functions as a program execution command which instructs the host server, database, web page application or program to access the Internet to locate and obtain information in response to the user specific data provided. It is understood that the application and/or program receives the user specific information provided by the network appliance as data that serves to fulfill an unknown variable. For example, a word or phrase provided to an Internet search engine serves as data for a previously unknown variable. The data is then used by the search engine's programmed algorithm as information for which the search engine locates similar terms, subject matter and meta data meta tags throughout the Internet. Applications which search the Internet for information are well known to those of ordinary skill in the art. Various ‘bots’ exist which search “.html” code or script of Internet documents and compile databases of cataloged information regarding the documents. The current invention may provide data in the form of user specific terms, for example, birth date, culinary or music preferences, or vehicle speed, to applications on the Internet which respond to the terms by searching and providing relevant information to the network appliance. The host server, web page, database or network native or resident program is prepared to access and locate, retrieve, and transmit information from the network where the information is specifically related to requests sent by the network appliance. The host (server) has the ability to utilize the network appliance inputs, that is, global positioning system (“GPS”) latitude/longtitude information, and specific user information requests to search a predetermined group of established websites. This predetermined group of established websites or webpages are part of the program and/or application database which resides on the host server that is provided queries or inputs from the network appliance.

In another embodiment of the invention, focused and/or selected Internet information is required. Information provided on an entire website server, or information within entire website folders stored on an Internet server host is analyzed for specific answers to network appliance input, data or query.

The network appliance provides a user access to various content areas, which may include: a) entertainment, b) information content, c) synchronization, and d) vehicle diagnostics, and the like. Table 1 illustrates a top level list of features and functionality for the network appliance.

TABLE 1

| FEATURE(S) | FUNCTION(S) |
|---|---|
| Entertainment | Tuner AM/FM Stereo |
| | MP3 Player |
| | WMA Player |
| | E-Books Player |
| Information: Location-Based | Directions |
| | Traffic Updates |
| | Fuel Level |
| | Restaurants |
| | Travel Information |
| Information: Time-Based | Weather |
| | Stock Quotes |
| | Movie Tickets/Schedule |
| | Horoscope |
| Bluetooth ™ | Synchronization |
| | Audio |
| | Dialing |
| Vehicle Diagnostics | Fault Warning |
| | Fault Disposition |

The entertainment aspect of the internet appliance provides a user with audio, image and/or video content. The audio can be in the form of a radio wave tuner such as an AM/FM stereo, digitally compressed music in formats such as MP3 or WMA, and the like. Other types of audio include digital electronic books, compact disc, digital video disc, and the like. Image content can be in the form of digital images such as .jpg, .gif. bmp, .tiff, .tga, formats and the like. Video content may be distributed as Internet-streamed digital images, mpeg files, or other formats such as .avi, .mov, .ra, .qtw, .asf and the like. Entertainment may also include information considered useful such as local, national, or international news.

Information content may be location-based or time-based. Location-based information includes content tailored to a user in a specific location, which will be achieved via content scraping from established websites. Current global positioning system (“GPS”) location from the Internet appliance can be sent to a website, from which the required Internet content is received. Location-based information includes content provided to the driver and/or user such as directions to a particular location, traffic updates, the amount of fuel in the car and the amount of fuel needed to arrive at a particular location, information on local businesses such as restaurants or other merchants, and travel information such as activities in the area. For example, with respect to directions, given a GPS location, the latitude and longitude of the location is transmitted along with requested directions to location(s) to a website such as www.mapquest.com™. The website will in turn download the directions, which will be text-based and read via a text to sound (“TTS”) engine.

With respect to traffic updates, a website such as www.trafficstation.com™ may be used. When the user queries the network appliance whether traffic delays are expected, the network appliance sends a latitude and longitude location corresponding to the current location and an established radius to report traffic incidents to the website. The website will in turn send down traffic events in the surrounding area of the last known latitude and longitude location. The user may elect continuous notification. In that case, the unit continues to process in intervals of every few minutes, for example, every four (4) minutes, and report any major traffic incidents along the route of travel. The user is then notified if a traffic incident exists.

With respect to fuel level, at the point the fuel light goes on, the network appliance looks for the nearest fuel station. The network appliance sends a latitude and longitude location to a website such as www.arcogas.com™. The website in turn sends down a recommendation for fueling at the nearest identified station. After the recommendation is sent, the network appliance requests whether the user would like to be routed to that gas station.

With respect to restaurant information, at specific times, for example, 12:00 PM, which may be specified by a user profile, the network appliance prompts the user and begins searching for restaurants that fit the user's established profile. The network appliance sends the latitude and longitude location to a website such as www.fodors.com™. The website in turn sends down recommendations for restaurants based upon location and profiled information. After the recommendation, the network appliance requests whether the user would like to be routed to that restaurant.

With respect to travel information, based upon a specific area location, the network appliance sends a latitude and longitude location to a website such as www.fodors.com™. The website offers suggestions for activities in the given location. Additionally, the user may elect a listing of other information such as nightlife clubs in a given location. This information is downloaded to the network appliance and read to the user using the TTS engine.

Time-based information includes perishable content that is important to the user. Similar to location-based content, time-based content is achieved via content scraping from established websites. Current GPS location from the network appliance can be sent to a website, from which the required Internet content is then received. Time-based information includes content provided to the user such as current weather conditions, stock quotes, scheduling and ticket buying opportunities, daily horoscope information, etc.

With respect to weather, a user has the ability to get a weather report for a specific location of the user by using a website such as www.weather.com™. The network appliance sends a latitude and longitude location to the website, which in turn sends down a weather forecast, for example, a five-day weather forecast for the current location of the user.

With respect to stock quotes, a user has the ability to get specific stock quotes downloaded to the network appliance by using a website such as www.etrade.com™. Rather than remembering a stock symbol, the network appliance preprocesses the request. For example, the user would only be required to state “what is Intel™ at?” The appliance will then know to go to a website such as www.etrade.com™ with a request for NASDAQ™ symbol “intl”. In addition, the user can establish a particular portfolio report based on an established time criteria that may be obtained from a user profile.

With respect to movie tickets, a user may receive movie schedule information and purchase movie tickets while en route to a movie theatre by using a website such as www.movietickets.com™ via the network appliance. The downloaded movie schedule information would be read via the TTS engine.

With respect to horoscopes, a user would be able to get astrological forecasts for various days including the current day, or the following day for the requested astrological sign. The downloaded information would be read via the TTS engine.

Synchronization is based on the network appliance using technologies such as Bluetooth™ wireless communications technologies to serve as an in-vehicle personal organization device, storage space, and database for information a user transmits to the appliance through use of a PDA or other device compatible with Bluetooth™ protocols. The network appliance can accept and transmit information to PDA's which use standard wireless protocols as well as provide telecommunications functions.

The network appliance may utilize Bluetooth™, which allows functionality as summarized in Table 2.

TABLE 2

| FEATURE(S) | FUNCTION(S) |
|---|---|
| Synchronization | Address Book Contents |
| Dialing | Handset |
| | Network Appliance |
| Audio | Car Audio Speakers |

Based upon established Bluetooth™ devices, the network appliance is able to synchronize address book contents, for example. The network appliance also allows call initiation and call receiving from a remote handset as well as from the network appliance itself. Without being bound by the tether of cabling, input and output audio can be moved into the car speaker system.

Vehicle diagnostics of the network appliance provides the ability to transmit and receive information relating to a vehicle's mechanical performance, mileage, and time-based and/or mileage-based appointments with a mechanic. Exemplary abilities of the vehicle diagnostics include monitoring a loose gas cap and overriding in-vehicle signals such as a “check engine” light which may flash ON to alert a user when a gas cap is loose. Furthermore, vehicle diagnostics alerts a user via the network appliance of a mechanical problem and further provides the user with information regarding the type of mechanical problem and the closest dealer or mechanic capable of repairing the malfunction. Such information is obtained by the network appliance through communication with the in-vehicle computer system that normally monitors mechanical aspects of the vehicle. Further, the network appliance may receive information from a vehicle dealership regarding scheduled maintenance visits. Other aspects of a vehicle that are monitored include, for example, door lock/unlock, trunk open/closed, interior climate controls, and the like. A user can control some aspects of a vehicle's functions, for example, locking and unlocking the doors, and starting the engine via wireless communication with the vehicle diagnostics functions of the network appliance.

Actions performed by a user while operating a vehicle generate data that may be in the form of digital representations. The physical interactions between a user and a vehicle are monitored, collected and categorized by the network appliance, which also collects data and/or information from, for example, pre-existing in-vehicle computer systems. Such systems currently monitor vehicular conditions, such as the speed of the vehicle, the amount of gas and/or oxygen flowing to the engine, and depressions of the clutch, brake or accelerator pedals. These activities may be interpreted by the in-vehicle computer system and represented as data accessed by or transmitted to the network appliance. Generally, the monitoring of in-vehicle diagnostics is performed by one or more in-vehicle computer processors which are attached to various buses placed in appropriate areas of the vehicle. The specific computer language and/or code used by in-vehicle computers can be standard or can be obtained from the automobile manufacturer. Additional systems such as GPS navigation systems can monitor the location and direction the vehicle is traveling and provide information to the appliance. The digital representations of such activities are collected by in-vehicle computer systems which can then provide the information to devices of the current invention, and conversely, devices of the current invention may access the information. Additional activities that can be monitored and digitally represented with regard to interactions between a user and in-vehicle components may include headlight status, radio tuner status, compact disc or digital video disc player status, GPS system, vehicular mobile communications device, and the like. Some of the digital representations remain resident in the network appliance stored in categorized databases, while other representations are transmitted via wireless Internet protocols to database servers, or used to access information via the world wide web. The digital representations of user interactions with a vehicle aid the network appliance in presenting personalized/user specific information to the user.

In another embodiment a network appliance receives and transmits information such as digital representations of a user's preferences. The network appliance is configured to either store user preferences on an internal storage component, such as a disc drive or an internal memory chip such as a flash memory chip, electrically erasable programmable read-only memory (EEPROM), or ferroelectric random access memory (FRAM), for example, or the appliance transmits user preferences to a network computer database server which catalogs and stores the information in an accessible manner. The preferences can be information such as the user's name, birth date, occupation, income range, hobbies, culinary preferences, stocks purchased or watched, appointments, music preferences, and addresses. The digital representations may be transmitted by the network appliance to a network, such as the Internet, through wireless communication components using wireless communications protocols and are used to establish a digital representation of the user that serves as demographic information of the user and can be selected by other users of the network, for example, business concerns, to provide the user information relative to the provided preferences. Personal preferences may be provided to the network appliance via speech or keypad entry by the user. The keypad entry can be through an alphanumeric keypad directly connected to the internet appliance, or by entry to an Internet webpage which is accessed by the network appliance. Further, personal preferences are transmitted to the network appliance by a PDA by either radio transmission, infra red transmission, or by direct connection using protocols such as BlueTooth™.

Thus, the network appliance is a device capable of accessing the Internet via wireless communication protocols, and provides information to a user safely and effectively. The device can be installed in a vehicle, such as an automobile, and is capable of interfacing with in-vehicle computer systems. Generally, the network appliance provides a user access and control of appliance-related applications that can be computer-centric or traditional vehicle-centric.

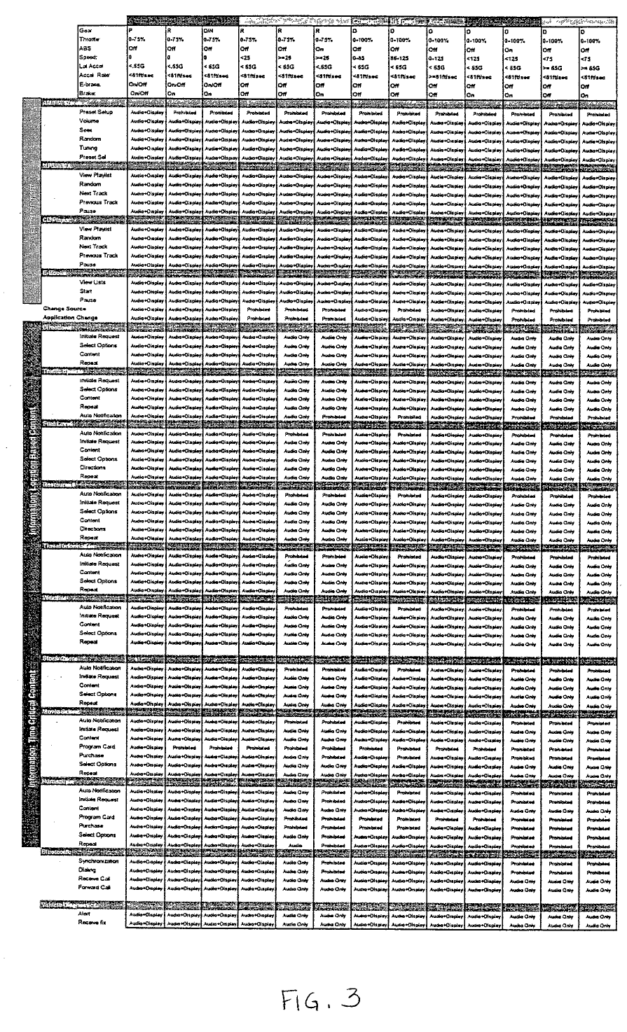

As described above, the network appliance offers a full set of features and provides great value in bringing Internet content to a user in a safe and effective manner. Specific criteria for operation parameters determines the content that can be safely offered to the user. During an unsafe situation, the network appliance allows maximum effort and focus to be given to the maneuver at hand. FIG. 3 provides an example framework for these situations.

FIG. 3 is a table showing exemplary content areas provided by the network appliance with respect to operational conditions according to an embodiment of the present invention. As an example, when the vehicle is in gear (“D”), which is the “drive” gear, at an exemplary constant speed of 0-85 miles per hour, for example, the entertainment, location-based and time-based information, Bluetooth™ and vehicle diagnostics are active on audio and display modes, except for the Preset Setup of the AM/FM stereo, the program card of the time-based information and the program card and purchase of the horoscope. Another example is when the vehicle is in gear (“R”), which is “reverse” gear, at an exemplary speed of greater than 26 miles per hour and with the brake “off”, several modes are prohibited including the Preset Setup of the AM/FM stereo, change setup and application change of the e-books function, auto notification of traffic update, fuel level, restaurant, travel information, stock quote, and movie schedule. Other modes are on audio only such as directions, traffic update, etc. Many other examples are depicted in FIG. 3.

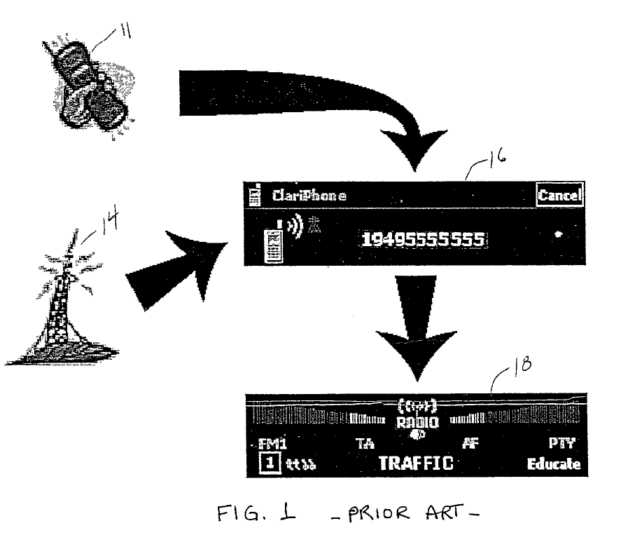

In traditional vehicular applications the standard user interface calls for interrupts to notify the user of events that may require his or her attention as described with respect to FIG. 1.

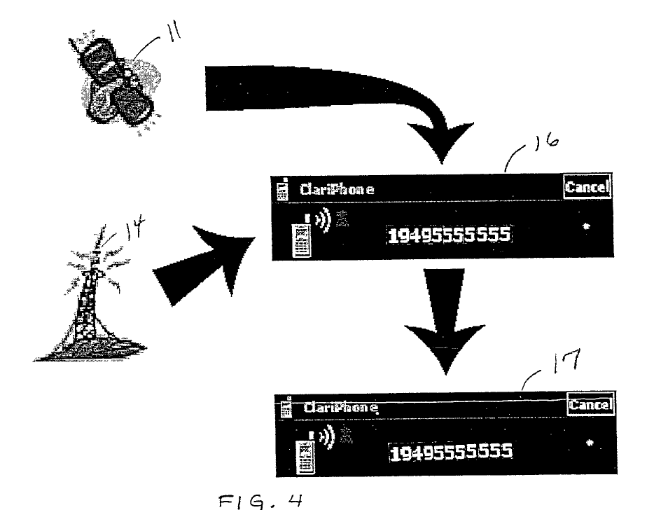

FIG. 4 illustrates an application priority manager implementation according to an embodiment of the present invention. If the same scenario as in FIG. 1 is used, embodiments of the present invention allow the traffic announcement to be ignored and keep the form and audio on the telephone application. A user talks on a telephone 11 with an onboard computer processing the audio. As shown in block 16, during the telephone call to a specific phone number, for example, 19495555555, transmitter 14 sends an RDS traffic announcement. At that point, as shown in block 17, the computer ignores the traffic announcement and keeps the form and audio on the telephone application, which has a higher priority task than the traffic announcement.

The dynamic application priority manager (“DAPM”) arbitrates the switching of applications and the different corresponding priority levels, and manages third party applications that do not have defined priority levels. Thus, the DAPM incorporates a means to distinguish whether or not an application has a priority level high enough to interrupt the current task.

To promote safe driving, certain application software on a vehicle computer generates interrupt conditions when running in the background. Examples of these applications and its conditions include: RDS traffic announcements, cellular telephone incoming prompt such as a ring, and navigation maneuver enunciation. The DAPM will know the priority level for both the form (display) and audio of the application that currently has focus. If a different application has an interrupt condition, this application will check with the DAPM to determine if its interrupt priority is higher than the application with current focus. If it is higher, it will take over the display, audio, or both, and will register itself with the DAPM.

As such, applications that have control, or request control, over the form and audio, register themselves with the DAPM. The DAPM maintains knowledge of the states of both the current display and audio priority levels and arbitrates when a different application requests access to either of these resources.

Different priority levels can exist for the audio and display. In addition, different priority levels can exist within a particular application. A cellular telephone application illustrates these two circumstances.

Case 1: When the cellular telephone has a call in progress, maintaining the audio channel is important, while maintaining the form (display) is not as important. Therefore the audio priority level will be set high, and the display priority level will be set lower.

Case 2: If the cellular telephone application does not have a call in progress, it will have a low priority for both form and audio.

Case 3: If the cellular telephone application detects an incoming call, the user is notified of the ring through the audio system, and the user may press a button to answer the telephone call. Therefore, both the form and audio priority levels will be set high.

The knowledge of the states of each of the applications is important in implementing the DAPM because they enable the DAPM to react to changes in each application, especially if the status of applications change during the processing of interrupts.

The DAPM may have many levels of priorities, for example, 256. The priority levels are defined for cases in which an application has focus of the display, audio, or both, and in which an application needs to interrupt another application.

Table 3 shows exemplary priority levels.

TABLE 3

| Relative | Relative Setting | | |
|---|---|---|---|
| Setting | (within | Priority | |
| (Overall) | Designated Group) | Level | Designation |
| Highest | Highest | 0 | Emergency |
| | Lowest | 84 | |
| | Highest | 85 | Alert |
| | Lowest | 169 | |
| | Highest | 170 | Notification |
| | Lowest | 254 | |
| Lowest | Lowest | 255 | Default |

Table 4 describes possible designations.

TABLE 4

| | Interrupting | Focused | |
|---|---|---|---|
| Designation | Application | Application | Example |
| Emergency | User is informed | Application delivers | RDS Alarm PTY |
| | of a critical event. | critical information | Category, Assist |
| | | to the user. | Button Press, |
| | | | Collision |
| | | | Avoidance. |
| Alert | User should be | Application is | RDS Traffic |
| | alerted to a time- | delivering time | Announcement, |
| | sensitive, but not | sensitive | Navigation |
| | critical event, and | information, but | Maneuver |
| | the event should | not critical | Announcement |
| | not supercede | information to | |
| | any emergency | the user. | |
| | situations | | |
| Notification | Application not | Application is | Incoming News |
| | critical and can | delivering non- | Message |
| | be interrupted. | critical, non-time | |
| | | sensitive | |
| | | information to the | |
| | | user. | |
| Default | N/A | Application not | |
| | | critical and can be | |
| | | interrupted. | |

The default settings for applications that do not register with the DAPM may be as follows:

Unregistered application w/ focus: 255 (lowest level)

Interrupting Application that is unregistered: 0 (highest level)

It should be noted that if an application has a focus that does not register with the DAPM, it is assumed to have a state of 255 for both the display and audio. It can therefore be interrupted at any time, by any application that has interrupting capabilities.

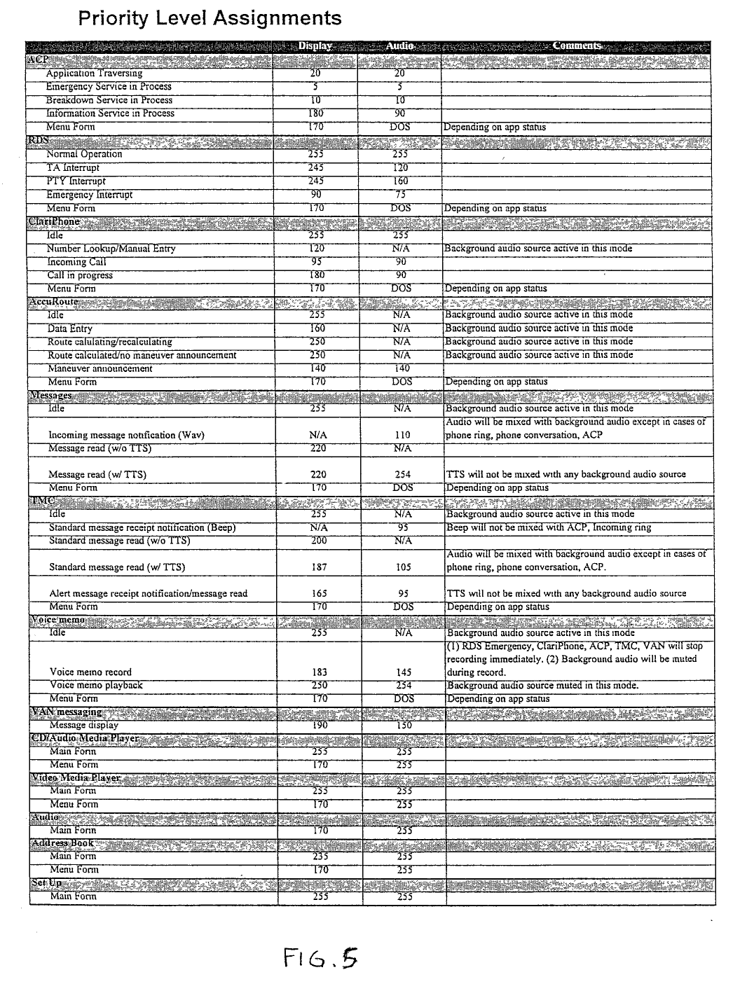

FIG. 5 is a table showing various priority level assignments according to an embodiment of the present invention. For example, under RDS, normal operation has a low priority of 255 for both display and audio, but an emergency interrupt has a much higher priority of 90 for display and 75 for audio.

If the application having focus and the interrupting application have the same priority level, the interrupting application will be allowed to take over the display and/or audio only after the current interrupt has been serviced, i.e. FIFO.

When nested interrupts occur, the DAPM has focus of the display and the audio. Likewise, after the interrupts are served, the DAPM ensures that the application previously holding focus of the display and audio is restored.

The DAPM enables independent interruptions of the display and audio when an application with a higher priority generates the interrupt. The DAPM must take into consideration the possibility of multiple, nested interrupts.

Nested interrupts occur when an application is interrupted by a different application, and during the servicing of the first interrupt, a second interruption occurs. In this situation, the DAPM continues to evaluate priority levels and only allows the interruption of the audio or display if the interrupting application has a higher priority for one of these resources.

Table 5 illustrates an example of interrupt nesting and results after an interrupt occurs.

TABLE 5

| | Priority | | Focus App after Interrupt | |
|---|---|---|---|---|
| Application | Display | Audio | Display | Audio |
| CD Player | 255 | 255 | CD Player | CD Player |
| RDS | 130 | 130 | RDS | RDS |
| (Traffic Alert) | | | | |
| Radar | 140 | 80 | RDS | Radar Detector |
| Detector | | | | |
| Navigation | 120 | 100 | Navigation | Radar Detector |
| (Maneuver | | | | |
| Announcement) | | | | |
| Cellular | 80 | 70 | Cellular | Cellular |
| Telephone | | | | |
| (Call Placed) | | | | |
| Collision | 1 | 1 | Collision | Collision |
| Avoidance | | | Avoidance | Avoidance |

After interrupts are serviced, the DAPM ensures that the correct application(s) retake the form and audio. To perform this, the DAPM maintains a log of applications that have caused interrupts, the priority level of each of these interrupts, and the current state of all applications.

If the application that was interrupted still requires servicing after the interrupting application routine has completed its task, the computer resumes servicing that application's routine as the routine requires. The following sequence illustrates this concept.

1. A compact disk (“CD”) application is interrupted by an RDS traffic announcement. The display and audio change to the RDS application.

2. The RDS traffic announcement is interrupted by a collision avoidance application. The display and audio change to the collision avoidance application.

3. The collision avoidance application completes its task while the RDS traffic announcement is still underway.

4. The DAPM instructs the RDS application to take over the display and audio.

5. The DAPM keeps the display and audio on the RDS traffic announcement until completed.

6. After the RDS traffic announcement is completed, the display and audio reverts back to the CD Application.

The DAPM determines if an application has serviced its interrupt while it is in the background. If so, the DAPM compares the new priority levels of that application with the application that it interrupted to determine the application(s) that should take over the display and audio. The following example illustrates this concept.

1. A CD application is interrupted by a cellular telephone prompt. The display and audio change to cellular application.

2. A navigation maneuver announcement occurs. The display changes to the navigation application while the cellular telephone prompt maintains the audio channel.

3. The cellular telephone prompt stops prior to completion of the navigation maneuver announcement.

4. When the navigation maneuver is completed, DAPM evaluates the priorities of the cellular telephone application versus the priorities of the CD application.

5. The DAPM independently restores the application(s) having the higher priority for the audio and the one(s) having the higher priority for the display.

The DAPM only controls whether an application interrupt will take over the form or audio. It does NOT arbitrate a user-initiated switch (e.g., manual button press, voice command) of the application. However, if the new application complies with the DAPM, the application continues to register its form and display priority levels to ensure that proper priority levels are established.

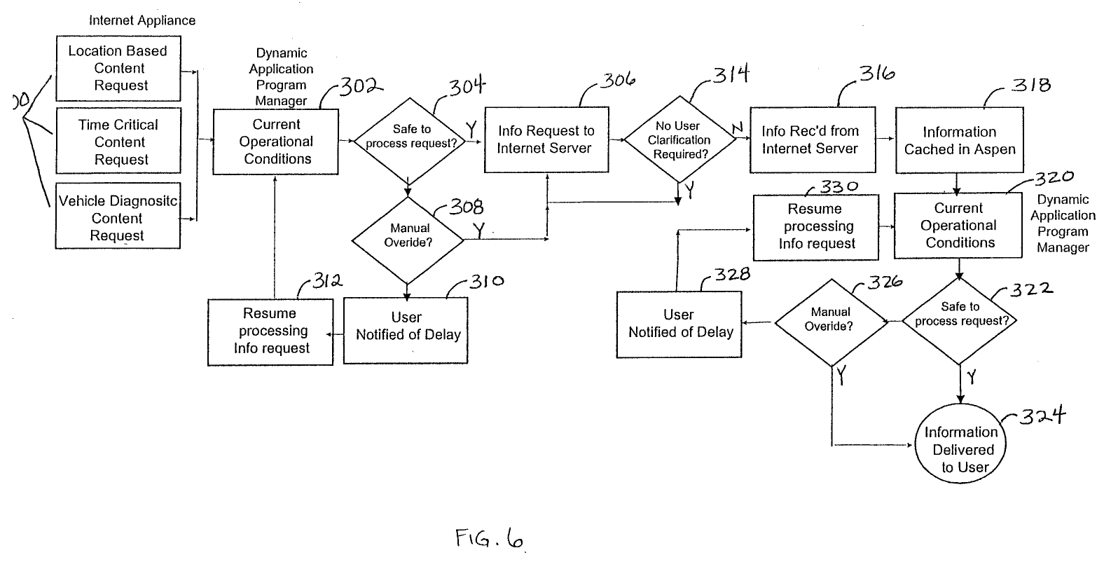

FIG. 6 shows a flow diagram of a system with a network appliance and a DDAPM according to an embodiment of the present invention. In step 300, a user may request information containing content such as location-based, time-based, or vehicle diagnostic content by using the network appliance. In step 302, the DAPM determines the current operational conditions of the vehicle. In step 304, the system determines if it is safe to process the request. If it is safe to process the request, the system goes to step 306 and sends the information request to a network server. In step 308, the system checks if there is a manual override by the user. If there is a manual override, the system continues to step 306 and sends the information request to a network server. If there is no manual override and it is not safe to process the information request, the system goes to step 310 and notifies the user of the delay. The system eventually resumes processing of the information request in step 312 and goes back to step 302 to repeat the process. In step 314, after the information request has been sent to the network server, the system checks whether a user clarification is required. If no clarification is required, the system goes to step 316 in which information is received from the network server. If there is clarification required, the system returns to step 306 and resends the information request to the network server. In step 318, the information received from the network server is cached in the network appliance. In step 320, the current operational conditions are checked by the DAPM. In step 322, the system checks if it is safe to process the request. If it is safe to process the request, the information is delivered to the user in step 324. In step 326, the system checks for a manual override from the user. If there is no manual override, the system goes to step 328 and notifies the user of the delay. In step 330, the system eventually resumes processing of the information request and goes back to step 320. If there is a manual override, the system goes to step 324 and delivers the information to the user. It should be noted that the steps described above may be implemented as computer instructions.

One skilled in the art would readily appreciate that the present invention is well adapted to obtain the ends and advantages mentioned, as well as those inherent therein. The specific methods and examples described herein as presently representative of embodiments are exemplary and are not intended as limitations on the scope of the invention. Changes therein and other uses will occur to those skilled in the art which are encompassed within the spirit of the invention are defined by the scope of the claims.

It will be readily apparent to one skilled in the art that modifications may be made to the invention disclosed herein without departing from the scope and spirit of the invention. For example, those skilled in the art will recognize that the invention may suitably be practiced using a variety of different methods and are within the general descriptions provided.

The invention illustratively described herein suitably may be practiced in the absence of any element or elements, limitation or limitations which is not specifically disclosed herein. Thus, for example, in each instance herein any of the terms “comprising,” “consisting essentially of” and “consisting of” may be replaced with either of the other two terms. The terms and expressions which have been employed are used as terms of description and not of limitation, and there is not intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group. For example, if there are alternatives A, B, and C, all of the following possibilities are included: A separately, B separately, C separately, A and B, A and C, B and C, and A and B and C.

Thus, additional embodiments are within the scope of the invention and within the following claims.

We claim:

1. A network appliance for communicating information comprising:
means for inputting information by a user;
memory means for electronically storing the information; and
processor means for communicating the information to and from a network, said information comprising digital representations of user preferences, and interactions between the user and a vehicle.

2. The network appliance of claim 1, wherein said information further comprises at least one of interactions between the vehicle and an in-vehicle computer, physical location of the user and the vehicle, physical destination of the user and the vehicle, physical location of a business, and business to consumer messages.

3. The appliance of claim 2, wherein said interactions between the vehicle and the in-vehicle computer further comprise at least one of monitoring fuel level, monitoring oil level, monitoring engine temperature, monitoring brake function and condition, monitoring gas cap placement, monitoring vehicle door status, monitoring transmission status, monitoring vehicle speed, monitoring engine speed, monitoring battery charge, monitoring body integrity, and monitoring physical proximity.

4. The network appliance of claim 1, wherein said network further comprises the Internet.

5. The network appliance of claim 1, wherein said network appliance is installed in the vehicle.

6. The network appliance of claim 1, wherein said vehicle further comprises at least one of an automobile, a boat, and a motorcycle.

7. The network appliance of claim 1, wherein said interactions between the user and the vehicle further comprise at least one of depressing an acceleration pedal, depressing a braking pedal, depressing a clutch pedal, turning a steering wheel, turning on headlights, turning on windshield wipers, turning on in-vehicle climate controls, turning on an engine, turning off the engine, releasing the acceleration pedal, and releasing the braking pedal.

8. The network appliance of claim 1, wherein said means for inputting information by a user further comprises means for inputting information via speech.

9. A method for communicating information between a vehicle and a system of networked computers, comprising the steps of:
requesting information from the system of networked computers;
determining operational conditions of the vehicle;
determining if the operational conditions are safe to process the request; and
if it is safe to process the request, sending the information request to the system of networked computers.

10. The method of claim 9, further comprising the steps of:
checking if there is a manual override by a user;
if there is a manual override, sending the information request to the system of networked computers; and
if there is no manual override, notifying the user of the delay and eventually resuming processing of the information request.

11. The method of claim 9, further comprising the steps of:
checking whether a user clarification is required;
if no clarification is required, receiving information from the system of networked computers; and
if clarification is required, resending the information request to the system of networked computers.

12. The method of claim 9, further comprising the steps of:
receiving information from the system of networked computers;
caching the information received;
checking operational conditions of the vehicle;
checking if the operational conditions are safe to process the received information; and
if it is safe to process the received information, delivering the received information to the user.

13. The method of claim 12, further comprising the steps of:
checking if there is a manual override by the user;
if there is no manual override, notifying the user of the delay and eventually resuming processing of the received information; and
if there is a manual override, delivering the received information to the user.

14. The method of claim 9, wherein said step of requesting information from the system of networked computers further comprises requesting at least one of location-based, time-based, and vehicle diagnostic information.

15. The method of claim 9, wherein said system of networked computers further comprises the Internet.

16. A network appliance comprising:
an input device to input information;
a processing unit capable of connecting to a system of networked computers;
a first computer instruction that directs said processing unit to receive a request for access to information from the system of networked computers;
a second computer instruction that determines operational conditions of the vehicle;
a third computer instruction that determines if the operational conditions are safe to process the request; and
a fourth computer instruction that sends the information request to the system of networked computers if it is safe to process the request.

17. The network appliance of claim 16, wherein the system of networked computers further comprises the Internet.

18. The network appliance of claim 16, wherein the input device further comprises a keyboard.

19. The network appliance of claim 16, further comprising
a fifth computer instruction that checks if there is a manual override by a user; and
a sixth computer instruction that sends the information request to the system of networked computers if there is a manual override.

20. The network appliance of claim 16, further comprising
a fifth computer instruction that directs said processing unit to receive information from the system of networked computers;
a sixth computer instruction that caches the information received;
a seventh computer instruction that checks operational conditions of the vehicle;
an eighth computer instruction that checks if the operational conditions are safe to process the received information; and
a ninth computer instruction that delivers the received information to the user if it is safe to process the received information.
